(19) United States
(12) Patent Application Publication
(10) Pub. No.: US 2009/0036133 A1
(43) Pub. Date: Feb. 5, 2009

(54) Apparatus and method for transmitting/receiving message for handover to heterogeneous system in broadband wireless access

(75) Inventors: Yung-Soo Kim, Seongnam-si (KR); Jong-Hyung Kwun, Seongnam-si (KR); Dai-Kwan Kim, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/220,853

(22) Filed: Jul. 29, 2008

(30) Foreign Application Priority Data
Jul. 30, 2007 (KR) 2007-0076334

(51) Int. Cl. H04Q 7/20

(52) U.S. Cl. 455/436; 370/331

(57) ABSTRACT

Provided is an apparatus and method for transmitting/receiving a message for a handover to a heterogeneous system in a BWA system. In the method, a neighboring BS information message containing the neighboring heterogeneous system BS information is generated according to the neighboring BS information message generation scheme of the serving system. The serving system BS has only to transmit information about a neighboring BS of the serving system, thus reducing a message overhead. Also, the neighboring heterogeneous system BS has only to transmit its own BS information within the corresponding coverage, thus enabling efficient use of control channel resources.

### CROSS-REFERENCE TO RELATED APPLICATION(S) AND CLAIM OF PRIORITY

This application claims priority under 35 U.S.C. § 119 to an application filed in the Korean Intellectual Property Office on Jul. 30, 2007 and assigned Serial No. 2007-76334, the contents of which are incorporated herein by reference.

### TECHNICAL FIELD OF THE INVENTION

The present invention relates generally to a broadband wireless access (BWA) system, and in particular, to an apparatus and method for transmitting/receiving a message to enable an efficient handover of a user terminal accessing a serving system to a neighboring heterogeneous system in a BWA system of a cellular environment with a plurality of heterogeneous systems.

### BACKGROUND OF THE INVENTION

In a BWA system of a cellular environment, there may be a case where the communication environment with a neighboring base station (BS) becomes better than the communication environment with a serving BS, with the lapse of time during communication, due to various factors such as the movement of a subscriber terminal, a change in propagation environment, and a rapid increase in the number of subscriber terminals in a specific cell. In this case, the subscriber terminal, the serving BS, and neighboring base stations must efficiently detect such a communication environment change to establish a new communication link using the optimal base stations. To this end, a handover process is required.

When a handover to a neighboring cell or a neighboring sector is required due to a change in the communication environment of a user terminal in the BWA system, the user terminal receives neighboring BS information and scanning information from a serving BS to perform a series of scanning operations for acquiring synchronization with the corresponding neighboring base stations by measuring the corresponding channel conditions. Herein, the neighboring BS information is received through a neighbor advertisement (NBR-ADV) message, and the scanning operations on the corresponding neighboring base stations are performed serially according to a neighboring BS list contained in the NBR-ADV message.

Because the NBR-ADV message is simultaneously broadcast to all the user terminals in a cell, the NBR-ADV message must contain information about all the neighboring base stations to which the user terminals in the cell are likely to perform a handover. Thus, an NBR-ADV message received from a serving BS of a serving system must contain not only information about neighboring base stations of the serving system but also information about base stations of a neighboring heterogeneous system in order for a user terminal to perform a handover to the neighboring heterogeneous system in the cellular environment of the next-generation communication system that has a mixture of base stations of heterogeneous systems coexisting in the same space.

As described above, the number of base stations whose information must be contained in the NBR-ADV message increases in the BWA system with a mixture of a plurality of heterogeneous systems. Thus, for the serving BS of the serving system, an overhead increases due to an increase in the size of the NBR-ADV message. Also, for the user terminal, a scanning interval increases due to an increase in the number of base stations to be scanned and thus a long time is taken to perform a pre-process operation for a handover to the neighboring heterogeneous system. Consequently, the increased scanning interval reduces a period of time to receive data from the serving BS of the serving system, thus reducing the system throughput. Also, the increased scanning interval increases the power consumption of the user terminal.

### SUMMARY OF THE INVENTION

To address the above-discussed deficiencies of the prior art, it is a primary object of the present invention to substantially solve at least the above problems and/or disadvantages and to provide at least the advantages below. Accordingly, an object of the present invention is to provide an apparatus and method for transmitting/receiving a message for a handover to a heterogeneous system in a BWA system.

Another object of the present invention is to provide an apparatus and method for enabling a BS of a neighboring heterogeneous system to generate an NBR-ADV message receivable by a user terminal, and to broadcast the generated NBR-ADV message to the user terminal through a frame of a serving system, in a BWA system of a cellular environment with a plurality of heterogeneous systems.

Still another object of the present invention is to provide an apparatus and method for enabling a user terminal to receive an NBR-ADV message from a BS of a neighboring heterogeneous system through a frame of a serving system currently accessed by the user terminal, in a BWA system of a cellular environment with a plurality of heterogeneous systems.

Even another object of the present invention is to provide an apparatus and method for supporting a rapid handover between heterogeneous systems by enabling a BS of a neighboring heterogeneous system to transmit its own BS information as a signal of a serving system accessed by a user terminal, in a BWA system of a cellular environment with a plurality of heterogeneous systems.

Yet another object of the present invention is to provide an apparatus and method for preventing an unnecessary scanning operation by a user terminal by reducing an overhead of an NBR-ADV message that must be periodically transmitted by a serving system BS, in a BWA system of a cellular environment with a plurality of heterogeneous systems.

According to one aspect of the present invention, a method for transmitting BS information from a BS of a neighboring system to a user terminal accessing a serving system includes: generating a neighboring BS information message containing the neighboring system BS information according to the neighboring BS information message generation scheme of the serving system or pre-defined scheme by the serving system, and transmitting the generated neighboring BS information message according to the neighboring BS information message transmission scheme of the serving system or pre-defined scheme by the serving system.

According to another aspect of the present invention, an apparatus for transmitting BS information from a BS of a neighboring system to a user terminal accessing a serving system includes: a neighboring BS information message generator for generating a neighboring BS information message containing the neighboring system BS information according to the neighboring BS information message generation scheme of the serving system or pre-defined scheme by the serving system, and a neighboring BS information message transmitter for transmitting the generated neighboring BS information message according to the neighboring BS information message transmission scheme of the serving system or pre-defined scheme by the serving system.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a BWA communication environment considered in the present invention;

FIG. 2 is a block diagram of a BS of a neighboring heterogeneous system in a BWA system of a cellular environment according to an embodiment of the present invention;

FIG. 3 is a flow diagram illustrating a method for transmitting an NBR-ADV message of a BS of a neighboring heterogeneous system in a BWA system of a cellular environment according to an embodiment of the present invention;

FIGS. 4A and 4B are diagrams illustrating examples of an NBR-ADV message generation scheme of a neighboring heterogeneous system BS;

FIGS. 5A and 5B are diagrams illustrating examples of a resource sharing scheme for NBR-ADV message transmission of neighboring heterogeneous systems; and

FIGS. 6A, 6B and 6C are diagrams illustrating a frame structure of a BWA system of a cellular environment according to an embodiment of the present invention.

### DETAILED DESCRIPTION OF THE INVENTION

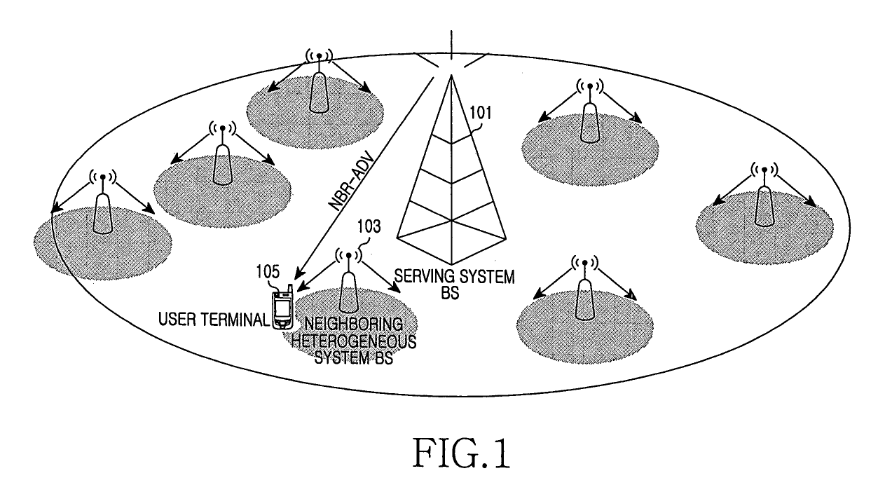

FIGS. 1 through 6C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless access system.

The present invention is intended to provide an apparatus and method for transmitting/receiving a message for a handover to a neighboring heterogeneous system in a broadband wireless access (BWA) system. Herein, the message should be construed as including all the messages necessary for a handover between heterogeneous systems. The following description is made in the context of a neighbor advertisement (NBR-ADV) message, to which the present invention is not limited. Herein, the NBR-ADV message may be transmitted periodically, or may be transmitted when a change in its information is detected. The following description is made on the assumption that the NBR-ADV message is transmitted periodically.

Also, the following description is made in the context of base stations of a serving system and a neighboring heterogeneous system such W-CDMA, WiMAX, LTE, UMB, to which the present invention is not limited. However, it should be clearly understood that the present invention is also applicable to handover procedure between the base stations that have different coverage areas in the single system.

FIG. 1 is a diagram illustrating a BWA communication environment considered in the present invention.

Referring to FIG. 1, the present invention considers a BWA communication environment with a mixture of different systems that can use different frequency bands. The following description is made on the assumption that there are two different systems, that is, a serving system (e.g., a IEEE 802.16e) and a neighboring system (e.g., a WCDMA). In case of single system, there are two different coverage (e.g., a macro-cell and a femto cell)

Herein, from the standpoint of a user terminal 105, a BS 101 of a serving system periodically generates an NBR-ADV message containing its own neighboring BS information in the same system, and broadcasts the generated NBR-ADV message to the user terminal 105. Also, a BS 103 of a neighboring heterogeneous system generates an NBR-ADV message containing its own BS information according to the NBR-ADV message generation scheme of the serving system, and transmits the generated NBR-ADV message using a partial frame in a frame structure of the serving system according to the NBR-ADV message transmission scheme of the serving system. To this end, base stations of the neighboring heterogeneous system receive information such as an NBR-ADV message generation scheme, a frequency used, a frame structure, and transmission timing (interval) from the BS of the serving system by a backhaul technique or a radio frequency (RF) technique. When the serving BS and the neighboring BS are in the same system and the NBR-ADV message transmission scheme is pre-defined, the neighboring BS need not to receive the above information.

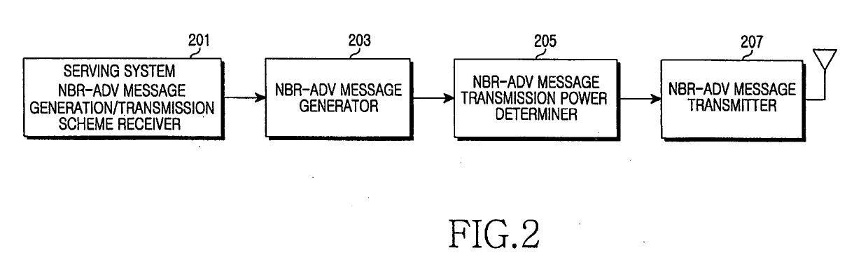

FIG. 2 is a block diagram of a BS of a neighboring heterogeneous system in a BWA system of a cellular environment according to an embodiment of the present invention.

Referring to FIG. 2, the neighboring heterogeneous system BS includes a serving system NBR-ADV message generation/transmission scheme receiver 201, an NBR-ADV message generator 203, an NBR-ADV message transmission power determiner 205, and an NBR-ADV message transmitter 207.

The serving system NBR-ADV message generation/transmission scheme receiver 201 is optional according to whether the neighboring system is different to the serving system. When the serving BS and the neighboring BS are in the same system and the NBR-ADV message transmission scheme is pre-defined, the neighboring BS does not require the serving system NBR-ADV message generation/transmission scheme receiver 201.

The serving system NBR-ADV message generation/transmission scheme receiver 201 receives information about an NBR-ADV message generation scheme and an NBR-ADV message transmission scheme from a BS of a serving system by a backhaul technique or an RF technique, and outputs the received information to the NBR-ADV message generator 203.

The NBR-ADV message generator 203 generates and outputs an NBR-ADV message containing the neighboring BS information of the neighboring heterogeneous system, according to the NBR-ADV message generation scheme of the neighboring heterogeneous system, during the NBR-ADV message transmission interval in the frame structure of the neighboring heterogeneous system. Also, using the information from the serving system NBR-ADV message generation/transmission scheme receiver 201 or pre-defined scheme by the serving system, the NBR-ADV message generator 203 generates and outputs an NBR-ADV message containing the neighboring heterogeneous system BS information, according to the NBR-ADV message generation scheme of the serving system, during the NBR-ADV message transmission interval in the frame structure of the serving system.

The NBR-ADV message transmission power determiner 205 determines transmission power for the NBR-ADV message, which is generated according to the NBR-ADV message generation scheme of the serving system or pre-defined scheme by the serving system, in consideration of the cell coverage of the neighboring heterogeneous system BS.

The NBR-ADV message transmitter 207 broadcasts the NBR-ADV message, which is generated according to the NBR-ADV message generation scheme of the neighboring heterogeneous system, during the corresponding frame interval in the frame structure of the neighboring heterogeneous system. Also, the NBR-ADV message transmitter 207 broadcasts the NBR-ADV message, which is generated according to the NBR-ADV message generation scheme of the serving system or pre-defined scheme by the serving system, in the corresponding frame interval in the frame structure of the serving system.

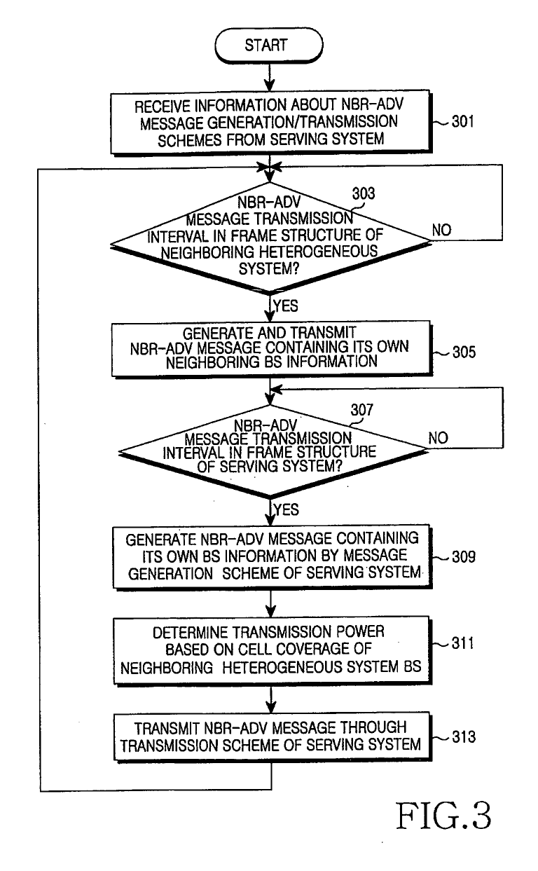

FIG. 3 is a flow diagram illustrating a method for transmitting an NBR-ADV message of a BS of a neighboring heterogeneous system in a BWA system of a cellular environment according to an embodiment of the present invention.

Referring to FIG. 3, in step 301, the neighboring heterogeneous system BS periodically receives information about an NBR-ADV message generation scheme and an NBR-ADV message transmission scheme from a BS of a serving system. According to the present invention, the NBR-ADV message, which is transmitted from the neighboring heterogeneous system BS to a user terminal accessing the serving system BS, has the same format as an NBR-ADV message of the serving system and is transmitted as a portion of a signal of the serving system BS. Therefore, the user terminal detects the NBR-ADV message of the neighboring heterogeneous BS as a signal transmitted from the serving system BS, and can receive the NBR-ADV message of the neighboring heterogeneous system BS without changing a receiving scheme. To this end, the neighboring heterogeneous system BS must know information about the NBR-ADV message generation scheme, the frequency used, the frame structure, and the transmission interval of the serving system accessed by the user terminal. Thus, the neighboring heterogeneous system BS must be able to receive information from the serving system BS, and the information may be received by a backhaul technique or an RF technique.

The step 301 is optional according to whether the neighboring system is different to the serving system. When the serving BS and the neighboring BS are in the same system and the NBR-ADV message transmission scheme is pre-defined, the neighboring BS can know information about the NBR-ADV message generation scheme without step 301.

In step 303, the neighboring heterogeneous system BS determines whether it is an NBR-ADV message transmission interval in the frame structure of the neighboring heterogeneous system. If it is the NBR-ADV message transmission interval in the frame structure of the neighboring heterogeneous system, the method proceeds to step 305. In step 305, the neighboring heterogeneous system BS generates an NBR-ADV message containing its neighboring BS information according to the NBR-ADV message generation scheme of the neighboring heterogeneous system, and broadcasts the generated NBR-ADV message.

In step 307, the neighboring heterogeneous system BS determines whether it is an NBR-ADV message transmission interval in the frame structure of the serving system. If it is the NBR-ADV message transmission interval in the frame structure of the serving system, the method proceeds to step 309. In step 309, the neighboring heterogeneous system BS generates an NBR-ADV message containing its own BS information according to the NBR-ADV message generation scheme of the serving system, in order to notify its own existence to the user terminal accessing the serving system.

Herein, the neighboring heterogeneous system BS uses a portion of the frame of the serving system to transmit the generated NBR-ADV message to the user terminal accessing the serving system, and the user terminal can receive the transmitted NBR-ADV message without a separate process because it regards the transmitted NBR-ADV message as a signal of the serving system. However, because the signal transmitted from the neighboring heterogeneous system BS to the user terminal of the serving system undergoes a different propagation environment than the signal of the serving system, independent channel estimation is required in the user terminal. That is, the user terminal could perform the channel estimation using a signal transmitted from the neighboring heterogeneous system BS, in order to receive a signal from the neighboring heterogeneous system BS.

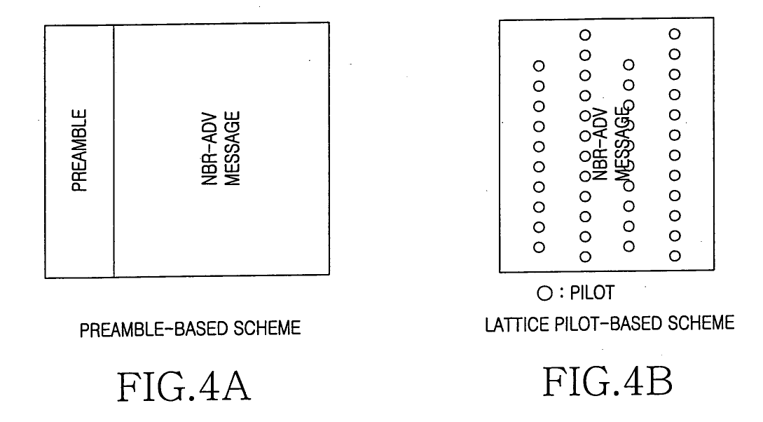

FIGS. 4A and 4B are diagrams illustrating examples of an NBR-ADV message generation scheme for the channel estimation. FIG. 4A illustrates an NBR-ADV message generation scheme using an independent preamble for channel estimation, and FIG. 4B illustrates an NBR-ADV message generation scheme using a lattice pilot.

In step 311, the neighboring heterogeneous system BS determines transmission power based on its own cell coverage. This allows user terminals entering within the pre-defined distance from the neighboring heterogeneous system BS, among user terminals accessing the serving system, to receive the NBR-ADV message, thereby preventing user terminals from receiving the neighboring heterogeneous system BS information unnecessarily.

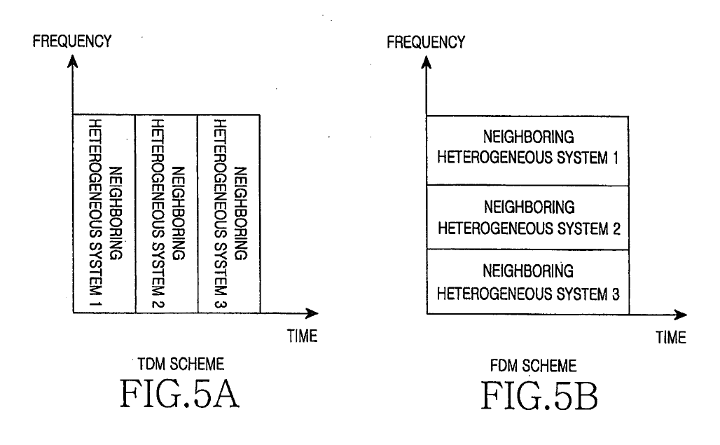

In step 313, the neighboring heterogeneous system BS uses a portion of the frame of the serving system to broadcast the generated NBR-ADV message through the transmission scheme of the serving system. Herein, if there are a plurality of neighboring heterogeneous systems for the user terminal, the neighboring heterogeneous systems may use independent NBR-ADV message transmission intervals (resources) or the same resource to transmit the NBR-ADV message, which is illustrated in FIGS. 5A and 5B. For example, as illustrated in FIG. 5A, the neighboring heterogeneous systems may use time division multiplexing (TDM) to divide an NBR-ADV message transmission interval so that they can share the NBR-ADV message transmission interval. Also, as illustrated in FIG. 5B, the neighboring heterogeneous systems may use frequency division multiplexing (FDM) to divide an NBR-ADV message transmission interval so that they can share the NBR-ADV message transmission interval. In other embodiments, the neighboring heterogeneous systems may use code division multiplexing (CDM) or spatial division multiplexing (SDM) to share the same NBR-ADV message field.

Thereafter, the neighboring heterogeneous system BS returns to step 303 to repeat the above operations.

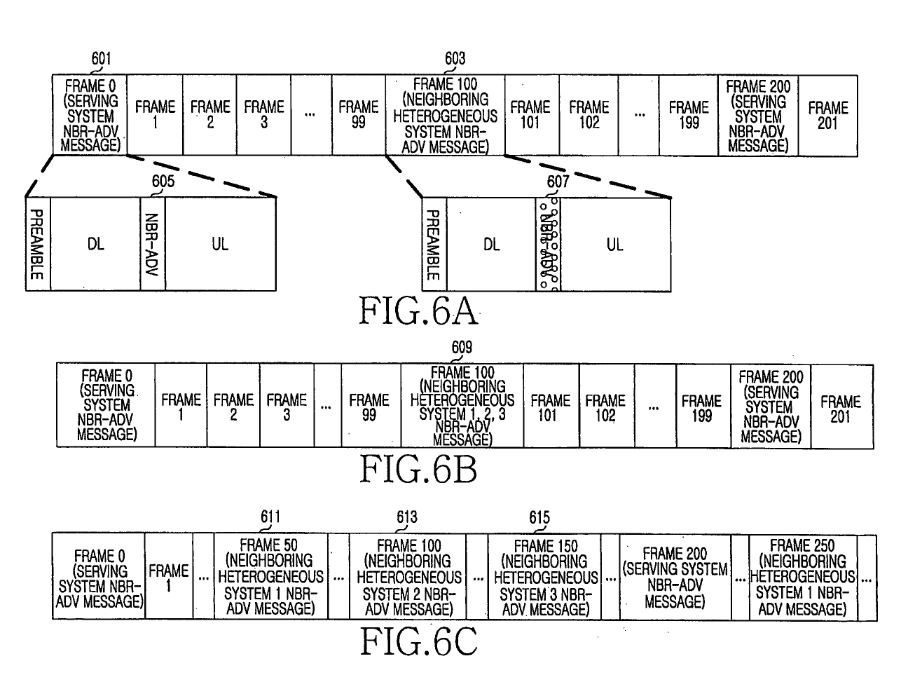

FIGS. 6A, 6B and 6C are diagrams illustrating a frame structure of a BWA system of a cellular environment according to an embodiment of the present invention. Herein, the frame structure is viewed from the standpoint of a user terminal, and the user terminal can receive a serving system NBR-ADV message and a neighboring heterogeneous system NBR-ADV message through a frame structure of the serving system.

Referring to FIGS. 6A, 6B and 6C, a serving system BS accessed by the user terminal transmits an serving system NBR-ADV message frame and a plurality of general frames, and then stops transmission during the interval for neighboring heterogeneous system NBR-ADV message frame, periodically. FIG. 6A illustrates an example where the serving system accessed by the user terminal has an NBR-ADV message transmission period of 200 frames. Herein, a neighboring heterogeneous system BS, which is not accessed by the user terminal, transmits its own NBR-ADV message between the NBR-ADV messages of the serving system. That is, the frame structure of the serving system may include a frame 601 containing an NBR-ADV message transmission interval 605 of the serving system, and a frame 603 containing an NBR-ADV message transmission interval 607 of the neighboring heterogeneous system after a plurality of general frames of the serving system. The serving BS of the serving system could stop transmission during the interval 607. Herein, the neighboring heterogeneous system NBR-ADV message transmitted in the NBR-ADV message transmission interval 607 of the neighboring heterogeneous system is the NBR-ADV message generated in the NBR-ADV message generation scheme of FIGS. 4A and 4B. Thus, the user terminal communicates with the serving system in the frame structure of the serving system, and communicates with the neighboring heterogeneous system only in the NBR-ADV message transmission interval 607 of the neighboring heterogeneous system.

Also, when there are a plurality of neighboring heterogeneous systems for the user terminal, the neighboring heterogeneous systems may transmit their NBR-ADV messages in the same frame 609 as illustrated in FIG. 6B, or may transmit their NBR-ADV messages in dependent frames 611, 613 and 615 as illustrated in FIG. 6C. Thus, the ratio between frames transmitting the serving system NBR-ADV message and the neighboring heterogeneous system NBR-ADV message may be 1:1 or 1:N. Herein, on the assumption that there are neighboring heterogeneous systems 1, 2 and 3 and a serving system accessed by the user terminal, FIG. 6B illustrates a case where the ratio between the serving system NBR-ADV message and the neighboring heterogeneous system NBR-ADV message is 1:1. In this case, the NBR-ADV messages of all the neighboring heterogeneous systems (except the serving system) coexist in the neighboring heterogeneous system NBR-ADV message according to the division scheme of FIGS. 5A and 5B. Also, FIG. 6C illustrates a case where the ratio between the serving system NBR-ADV message and the neighboring heterogeneous system NBR-ADV message is 1:3. In this case, the neighboring heterogeneous systems transmit their respective NBR-ADV messages in turn. Herein, because the NBR-ADV messages of the respective neighboring heterogeneous systems are transmitted using the transmission scheme of the serving system, the user terminal can receive the neighboring heterogeneous system BS information without using an additional receiving device or changing the carrier frequency.

According to the present invention as described above, the neighboring heterogeneous system BS generates an NBR-ADV message receivable by a user terminal, and broadcasts the generated NBR-ADV message to the user terminal through a frame of a serving system currently accessed by the user terminal, in a BWA system of a cellular environment with a plurality of heterogeneous systems. Also, the user terminal receives an NBR-ADV message from the neighboring heterogeneous system BS through a frame of the serving system currently accessed by the user terminal. Therefore, the serving system BS has only to transmit information about a neighboring BS of the serving system, thus making it possible to reduce a message overhead. Also, the neighboring heterogeneous system BS has only to transmit its own BS information within the corresponding coverage, thus enabling efficient use of control channel resources. Also, the user terminal has only to receive BS information of a necessary neighboring heterogeneous system. Therefore, an unnecessary scanning operation of the user terminal is prevented and the scanning time and power can be saved, thus making it possible to increase the data rate of the user terminal. Also, a decrease in the scanning time for a handover provides a more flexible handover. Also, because the serving system BS does not need to detect the location information of neighboring heterogeneous system base stations and user terminals, it is not necessary to support a separate location-based service (LBS).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting base station (BS) information from a base station of a neighboring system to a user terminal accessing a serving system, the method comprising:
generating a neighboring BS information message containing the neighboring system BS information according to the neighboring BS information message generation scheme of the serving system or pre-defined scheme by the serving system, and
transmitting the generated neighboring BS information message according to the neighboring BS information message transmission scheme of the serving system or pre-defined scheme by the serving system.

2. The method of claim 1, wherein the neighboring system is different to the serving system, it further comprising:
receiving information about the neighboring BS information message generation/transmission schemes of the serving system from the serving system BS.

3. The method of claim 2, wherein the information about the neighboring BS information message generation/transmission schemes of the serving system are received by a backhaul technique or by a radio frequency (RF) technique.

4. The method of claim 1, wherein the neighboring BS information message is generated by an addition of an independent preamble or by an insertion of a pilot symbol so that the user terminal accessing the serving system can estimate a channel of the neighboring system base station.

5. The method of claim 1, wherein the generated neighboring BS information message is transmitted in a corresponding frame in a frame structure of the serving system.

6. The method of claim 5, wherein the frame structure of the serving system comprises a frame including a transmission interval for a neighboring BS information message generated by the neighboring system base station.

7. The method of claim 6, wherein the transmission interval for the neighboring BS information message generated by the neighboring system base station is divided by time division multiplexing (TDM) or by frequency division multiplexing (FDM) so that one or more neighboring systems share the corresponding transmission interval.

8. The method of claim 6, wherein if there are a plurality of neighboring systems, the transmission interval for the neighboring BS information message generated by the neighboring system base station is included in an independent frame for each neighboring system.

9. The method of claim 1, further comprising determining the transmission power of the generated neighboring BS information message according to the cell coverage of the neighboring system base station.

10. The method of claim 9, wherein the transmission power of the generated neighboring BS information message is determined so that only user terminals entering the cell of the neighboring system base station among user terminals accessing the serving system, can receive the corresponding messages.

11. The method of claim 1, wherein the neighboring BS information message is a neighbor advertisement (NBR-ADV) message.

12. An apparatus for transmitting base station (BS) information from a base station of a neighboring system to a user terminal accessing a serving system, the apparatus comprising:
a neighboring BS information message generator for generating a neighboring BS information message containing the neighboring system BS information according to the neighboring BS information message generation scheme of the serving system or pre-defined scheme by the serving system, and
a neighboring BS information message transmitter for transmitting the generated neighboring BS information message according to the neighboring BS information message transmission scheme of the serving system or pre-defined scheme by the serving system.

13. The apparatus of claim 12, wherein the neighboring system is different to the serving system, it further comprising:
a receiver for receiving information about the neighboring BS information message generation/transmission schemes of the serving system from the serving system BS.

14. The apparatus of claim 13, wherein the information about the neighboring BS information message generation/transmission schemes of the serving system are received by a backhaul technique or by a radio frequency (RF) technique.

15. The apparatus of claim 12, wherein the neighboring BS information message is generated by an addition of an independent preamble or by an insertion of a pilot symbol so that the user terminal accessing the serving system can estimate a channel of the neighboring system base station.

16. The apparatus of claim 12, wherein the neighboring BS information message transmitter for transmitting the generated neighboring BS information message in a corresponding frame in a frame structure of the serving system.

17. The apparatus of claim 16, wherein the frame structure of the serving system comprises a frame including a transmission interval for a neighboring BS information message generated by the neighboring system base station.

18. The apparatus of claim 17, wherein the transmission interval for the neighboring BS information message generated by the neighboring system base station is divided by time division multiplexing (TDM) or by frequency division multiplexing (FDM) so that one or more neighboring systems share the corresponding transmission interval.

19. The apparatus of claim 17, wherein if there are a plurality of neighboring systems, the transmission interval for the neighboring BS information message generated by the neighboring system base station is included in an independent frame for each neighboring system.

20. The apparatus of claim 12, further comprising a determiner for determining the transmission power of the generated neighboring BS information message based on the cell coverage of the neighboring system base station.

21. The apparatus of claim 20, wherein the transmission power of the generated neighboring BS information message is determined so that only user terminals entering the cell of the neighboring system base station, among user terminals accessing the serving system, can receive the corresponding messages.

22. The apparatus of claim 12, wherein the neighboring BS information message is a neighbor advertisement (NBR-ADV) message.
